(19) United States
(12) Patent Application Publication
(10) Pub. No.: US 2009/0323947 A1
(43) Pub. Date: Dec. 31, 2009

(54) METHOD OF CONFIRMING DRIVE UNIQUE KEY AND OPTICAL DISC RECORDING/REPRODUCING APPARATUS

(75) Inventors: Shohei Aoyama, Mito (JP); Tetsuya Ikeda, Fujisawa (JP)

Correspondence Address: MCDERMOTT WILL & EMERY LLP, 600 13TH STREET, N.W., WASHINGTON, DC, 20005-3096, US

(73) Assignee: HITACHI-LG DATA STORAGE, INC.

(21) Appl. No.: 12/423,597

(22) Filed: Apr. 14, 2009

(30) Foreign Application Priority Data
Jun. 30, 2008 (JP) 2008-170612

(51) Int. Cl. H04N 7/167; H04L 9/00

(52) U.S. Cl. 380/201; 380/277

(57) ABSTRACT

In an apparatus which encrypts and records, or decrypts and reproduces content necessitated copyright protection using a plurality of encryption keys, the encryption key unique to a drive apparatus is stored into a memory in the apparatus at the time of manufacturing the apparatus.

According to the present invention, the presence or absence of encryption key information in a recording apparatus, a reproducing apparatus, or a recording/reproducing apparatus can be easily confirmed

When the encryption key unique to the drive apparatus is mounted, a flag indicating the presence of the encryption key is turned on. In other case, when receiving a command to confirm the presence of the encryption key from the outside of the apparatus, the flag which is turned on after confirming the presence of the encryption key by firmware of the apparatus is returned.

### CLAIM OF PRIORITY

The present application claims priority from Japanese patent application serial no. JP 2008-170612, filed on Jun. 30, 2008, the content of which is hereby incorporated by reference into this application.

### BACKGROUND OF THE INVENTION

1. Field of the Invention

The present invention relates to an encryption key of an apparatus for recording or reproducing encrypted information for copyright protection, and particularly to a method of easily managing key information unique to a drive unit of the apparatus.

2. Description of the Related Art

In a recording/reproducing apparatus with a digital recording method using optical media such as a DVD (Digital Versatile Disc) and a BD (Blu-ray Disc), there is a need of taking measures for copyright protection due to high quality of reproduced images and less deterioration of quality of replication. In order not to reproduce content necessitated copyright protection other than a specified reproducing apparatus and a specified user, encryption recording is performed.

In order to encrypt and record information or to reproduce the information, it is necessary for a drive apparatus to store unique key information for encryption or decryption thereof.

Japanese Patent Application Laid-Open No. 2005-039480 discloses a recording apparatus which encrypts and records content necessitated copyright protection using a plurality of encryption keys.

### SUMMARY OF THE INVENTION

A part of the encryption keys is stored into a non-volatile memory inside an apparatus at the time of manufacturing the apparatus. If the encryption keys are not correctly stored due to some error, or if forgot to store, an operation of correct encryption or decryption can not be naturally performed. However, since the encryption and decryption are performed by combining a plurality of techniques as described in Japanese Patent Application Laid-Open No. 2005-039480, various causes are conceivable in the problem of the operation. Therefore, in order to specify the cause, many processes are required.

An object of the present invention is to solve the above-described problem and to provide a method of, when a problem occurs at the time of performing an encryption operation or decryption operation due to a trouble in storing an encryption key, easily specifying its cause.

In order to achieve the above-described object, the present invention provides a method of confirming a drive unique key which is one of encryption keys used in a drive apparatus that records information including video and audio encrypted by using an encryption application into an optical disc recording medium, or a drive apparatus that reproduces the encrypted and recorded information from the optical disc recording medium for decryption, the method including: a storing step of storing the drive unique key into a storage unit of the drive apparatus; a flag generating step of generating a flag indicating whether or not the drive unique key is stored into the drive apparatus; a command generating step of generating a command checking the presence or absence of the drive unique key in the storage unit of the drive apparatus; and an outputting step of outputting the flag stored into the storage unit in response to the command.

Further, the present invention provides a method of confirming a drive unique key which is one of encryption keys used in a drive apparatus that records information including video and audio encrypted by using an encryption application into an optical disc recording medium, or a drive apparatus that reproduces the encrypted and recorded information from the optical disc recording medium for decryption, the method including: a command generating step of generating a command checking the presence or absence of the drive unique key; a checking step of checking the presence or absence of the drive unique key in the drive apparatus in response to the command; a flag generating step of generating a flag indicating the presence or absence of the drive unique key in response to the checking result of the checking step; and an outputting step of outputting the flag generated in the flag generating step.

Further, the present invention provides an optical disc recording/reproducing apparatus having a drive which records information including video and audio encrypted by using an encryption application into an optical disc recording medium and reproduces the encrypted and recorded information for decryption, the apparatus including: a recording unit which records the information including the input video and audio as encoded recording content; a reproducing unit which reproduces the encrypted recording content from the optical disc recording medium, and decrypts the encryption to be output; a storage unit which stores a drive unique key that is used for the encryption and its decryption and is unique to the drive; a controlling unit which generates a flag indicating the presence or absence of the drive unique key in the storage unit; an inputting unit which inputs a command checking the presence or absence of the drive unique key in the storage unit; and an outputting unit which outputs the flag generated by the controlling unit in response to the command.

According to the present invention, the presence or absence of encryption key information in a recording apparatus, a reproducing apparatus, or a recording/reproducing apparatus can be easily confirmed, so that the cause of a problem in encryption, decryption, or system authentication can be easily specified, thus contributing to improvement of usability for a user or a service person of the apparatus.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of a recording/reproducing apparatus showing an embodiment of the present invention;

FIG. 2 is a plan view of an optical disc; and

FIGS. 3A and 3B are operational flowcharts, each showing the embodiment of the present invention.

### DETAILED DESCRIPTION OF THE EMBODIMENT

Hereinafter, an embodiment of the present invention will be described with reference to the drawings.

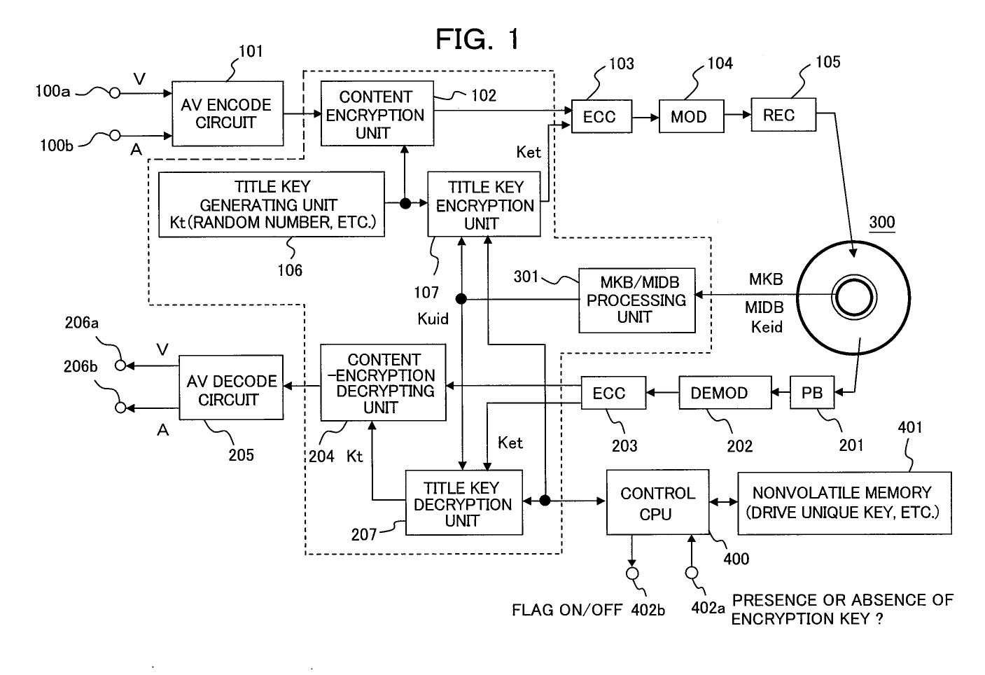

FIG. 1 is a circuit block diagram of a recording/reproducing apparatus showing an embodiment of the present invention.

First, a recoding operation will be described. Data of a video signal (V) of content to be recorded are input from an input terminal 100a, and data of an audio signal (A) thereof are input from an input terminal 100b. The input data is compressed by an AV encoding circuit 101 using MPEG2 (Moving Picture Experts Group 2), AC-3 (Audio Code Number 3) and the like. The data are time-division multiplexed, and then are encrypted by a content encryption unit 102 using an encryption key. Then, an error correction code used for correcting an error of data in a recording/reproducing process is added to the encrypted data by an ECC (Error Correction Code) circuit 103. Thereafter, the resultant data are converted into a code suitable for recording by an MOD (Modulator) circuit 104 using, for example, an 8-16 modulation scheme, and the code is power-amplified by an REC (Record) circuit 105 to be recoded into a content recording area of an optical disc 300. In addition, information of an encryption key which will be described later is also input to the ECC circuit 103, and is recorded into the content recording area.

Next, an operation of the content encryption unit 102 and the information of the encryption key input to the ECC circuit 103 will be described.

In the content encryption unit 102, content information output from the AV encoding circuit 101 is encrypted by, for example, scramble arithmetic processing using a title key Kt generated by a title key generating unit 106. As one example of a method of generating the title key by the title key generating unit 106, a random number is generated when being instructed to record a title including the video data and the audio data, and the random number is used as a title key.

In order to decrypt the encryption when reproducing information, which will be described later, it is necessary to record the title key Kt used for encryption into a recording medium. The title key Kt is encrypted by a title key encryption unit 107 so as not to be easily recognized, and then is recorded into the content recording area of the optical disc 300 through the ECC circuit 103 and the like. One example thereof will be described next.

A title encryption key Kuid is supplied to the title key encryption unit 107. The title encryption key Kuid is generated on the basis of MKB (Media Key Block), MIDB (Media Identification Block), and encryption media ID (Identification) Keid which are recoded into areas other than the content recording area of the disc and read. MKB is generated by performing arithmetic processing for a media key Km issued by its copyright owner on the basis of a device key Kd. MIDB is generated by performing arithmetic processing for a media unique key Kum given by its copyright owner on the basis of a plurality of media IDs (not shown). Keid is generated by encrypting the media IDs using the media key Km. Keid is operated together with MKB and MIDB by an MKB/MIDB processing unit 301 to generate the title encryption key Kuid.

The title key Kt is encrypted by the title key encryption unit 107 using the title encryption key Kuid. Therefore, a title key Ket after encryption is generated after combined encryption processes are carried out using the key given by the copyright owner and the device key, and it is impossible to easily recognize the original title key Kt.

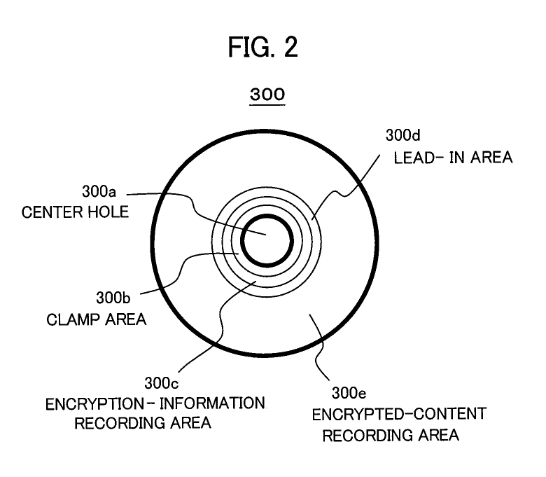

FIG. 2 is a plan view of the optical disc 300. As well known in the art, a center hole 300a is provided in the center of the optical disc 300, and a clamp area 300b for fixing at a fixed position of a drive is provided around the center hole 300a. On the outer side of the clamp area 300b, there is provided an encryption information recording area 300c into which encryption information for copyright protection as well as the encryption keys such as MKB, MIDB, and Keid are recorded. On the outer side of the encryption information recording area 300c, there is provided a lead-in area 300d into which the arrangement of recoded content information is recorded. On the outer side of the lead-in area 300d, there is provided an encrypted content recording area 300e which spreads up to near the outermost circumference.

Referring back to FIG. 1, a reproducing operation will be described. Information reproduced from the content recording area of the optical disc 300 is amplified and its amplitude and phase are equalized by a PB (Play Back) circuit 201. Then, for example, 8-16 modulation at the time of recording is demodulated by a DEMOD (Demodulator) circuit 202, and an error of data caused by recording and reproducing is corrected by an ECC circuit 203. Then, the encryption is decrypted using the title key Kt by a content-encryption decryption unit 204, and the data compression at the time of recording is stretched so as to be released by an AV decoding circuit 205, so that the data of the original video signal and audio signal are output to output terminals 206a and 206b.

The encrypted title key Ket is also output from the ECC circuit 203, and is supplied to a title key decryption unit 207. The title encryption key Kuid is obtained by the MKB/MIDB processing circuit 301 by performing arithmetic processing using MKB, MIDB, and Keid reproduced from the encryption information recording area 300c of the optical disc. Therefore, the encryption of the title key is decrypted by the title key decryption unit 207 to obtain the original title key Kt. Accordingly, decryption can be performed by the content-encryption decryption unit 204.

Many of the signal processing in FIG. 1 are carried out by software. Especially, a portion encircled by the dash line in FIG. 1 which involves encryption and decryption is operated by application software in many cases, and is operated after transmitting and receiving authentication to/from the drive side.

The above-described drive unique key is one of the device keys Kd given to a drive apparatus at the time of manufacturing. A drive unique key in accordance with, for example, AACS (Advanced Access Content System), VCPS (Video Content Protection System) or the like is already used. The drive unique key is necessary for the operation of encryption and decryption and system authentication.

Next, there will be described a method of confirming whether or not the drive unique key is correctly stored. In the case where the drive unique key is not correctly stored at the time of manufacturing, if a recording or reproducing operation is performed after being assembled as a recording apparatus, a reproducing apparatus, or a recording/reproducing apparatus, the recording or reproducing operation can not be correctly performed as an inevitable consequence. If a problem is specified during an encryption or decryption process, it is difficult to further narrow down its cause in many cases due to the complicated encryption or decryption process as described above.

The embodiment is characterized in that it is possible to easily confirm whether or not the drive unique key is correctly stored into, for example, a nonvolatile memory 401 using a control CPU 400 of FIG. 1. First, a flag indicating the presence of the drive unique key is provided. As one method, the drive unique key is mounted, and at the same time, the flag is held by the nonvolatile memory 401 while the flag is turned on. When it is necessary to confirm the presence of the drive unique key again after completion of the apparatus, a command inquiring about the presence or absence of the drive unique key is input from an input terminal 402a, and the command CPU 400 retrieves the flag in response to the command to output the flag to an output terminal 402b.

The following alternative method may be employed. At the time when whether or not the drive unique key is correctly stored becomes a problem, the control CPU 400 checks the storage of the drive unique key with firmware of the apparatus in response to the command from the input terminal 402a, and generates the flag in accordance with the result to output the same to the output terminal 402b. In this way, it is possible to easily confirm the state of the drive unique key.

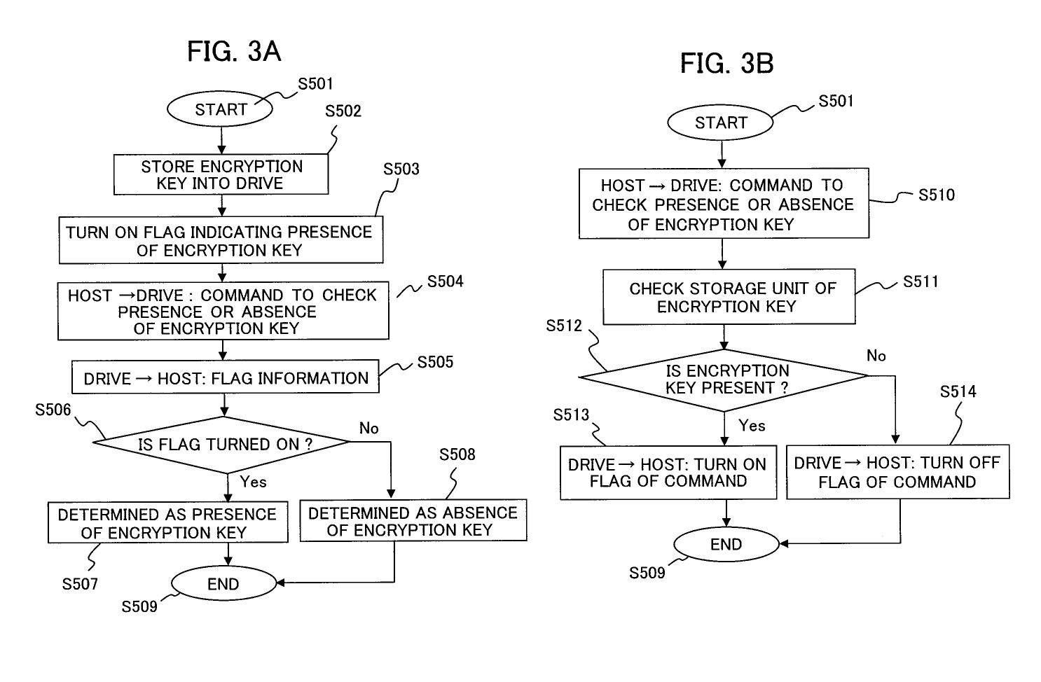

Next, a flow of the above-described operation will be described with reference to FIG. 3. “S” in the flowchart indicates respective operational steps. In the case of FIG. 3A, the operation starts with S501. First, the drive unique key is stored into the drive in S502, and the flag indicating the presence of the key is turned on in S503. If a command is generated so as to check the presence or absence of the key from the host to the drive in S504, the drive returns the flag to the host in S505. If it is confirmed that the flag is on in S506 (YES in the flowchart), it is determined that the drive unique key is present in S507, and the operation is terminated in S509. On the contrary, if it is confirmed that the flag is off in S506 (NO in the flowchart), it is determined that the drive unique key is absent in S508, and the operation is terminated in S509.

In the case of FIG. 3B, the operation starts with S501. If a command checking the drive unique key is transmitted from the host to the drive in S510, the storage unit of the encryption key is checked with firmware in S511. If it is determined that the encryption key is present in S512 (YES in the flowchart), an instruction is issued to return the flag from the drive to the host while turning on the flag in S513, and the operation is terminated in S509. On the contrary, if it is determined that the encryption key is absent in S512 (NO in the flowchart), an instruction is issued to return the flag from the drive to the host while turning off the flag in S514, and the operation is terminated in S509.

In the explanation of FIG. 1, constituent elements are not especially shown in the process of supplying the information such as MKB recorded into the encryption information recording area of the optical disc 300 to the MKB/MIDB processing circuit 301. This is because the drawing is made simple, and constitutional elements corresponding to the PB circuit 201, the DEMOD circuit 202, and the ECC circuit 203 may be actually provided.

Further, the present invention can be applied to a reproducing-only apparatus without a recording function and a recording-only apparatus without a reproducing function as well as a recording/reproducing apparatus, which falls within a range of the present invention.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A method of confirming a drive unique key which is one of encryption keys used in a drive apparatus that records information including video and audio encrypted by using an encryption application into an optical disc recording medium, or a drive apparatus that reproduces the encrypted and recorded information from the optical disc recording medium for decryption, the method comprising:
a storing step of storing the drive unique key into a storage unit of the drive apparatus;
a flag generating step of generating a flag indicating whether or not the drive unique key is stored into the drive apparatus;
a command generating step of generating a command checking the presence or absence of the drive unique key in the storage unit of the drive apparatus; and
an outputting step of outputting the flag stored into the storage unit in response to the command.

2. A method of confirming a drive unique key which is one of encryption keys used in a drive apparatus that records information including video and audio encrypted by using an encryption application into an optical disc recording medium, or a drive apparatus that reproduces the encrypted and recorded information from the optical disc recording medium for decryption, the method comprising:
a command generating step of generating a command checking the presence or absence of the drive unique key;
a checking step of checking the presence or absence of the drive unique key in the drive apparatus in response to the command;
a flag generating step of generating a flag indicating the presence or absence of the drive unique key in response to the checking result of the checking step; and
an outputting step of outputting the flag generated in the flag generating step.

3. An optical disc recording/reproducing apparatus having a drive which records information including video and audio encrypted by using an encryption application into an optical disc recording medium and reproduces the encrypted and recorded information for decryption, the apparatus comprising:
a recording unit which records the information including the input video and audio as encoded recording content;
a reproducing unit which reproduces the encrypted recording content from the optical disc recording medium, and decrypts the encryption to be output;
a storage unit which stores a drive unique key that is used for the encryption and its decryption and is unique to the drive;
a controlling unit which generates a flag indicating the presence or absence of the drive unique key in the storage unit;
an inputting unit which inputs a command checking the presence or absence of the drive unique key in the storage unit; and
an outputting unit which outputs the flag generated by the controlling unit in response to the command.
